(19) United States
(12) Patent Application Publication
(10) Pub. No.: US 2015/0044387 A1
(43) Pub. Date: Feb. 12, 2015

(54) POWDER-COATING APPARATUS AND POWDER-COATING METHOD

(71) Applicant: Robert Bosch GmbH, Stuffgart (DE)

(72) Inventors: Alexander Klonczynski, Bamberg (DE); Jens Koenig, Markgroeningen (DE); Thomas Kretschmar, Bamberg (DE); Sonja Dudziak, Bietigheim-Bissingen (DE)

(73) Assignee: Robert Bosch GmbH, Stuttgart (DE)

(21) Appl. No.: 14/385,495

(22) PCT Filed: Jan. 30, 2013
(86) PCT No.: PCT/EP2013/051714

§ 371 Date: Sep. 15, 2014

(30) Foreign Application Priority Data
Mar. 15, 2012 (DE) 10 2012 204 091.9

(51) Int. Cl. B05B 7/22; B05D 1/12; B05B 15/00; B05D 3/06; B05B 7/14

(52) U.S. Cl. CPC B05B 7/228; B05D 3/06; B05B 7/14; B05B 15/00; B05D 1/12
USPC 427/532; 118/620; 118/666; 118/641

(57) ABSTRACT

The present invention relates to a powder-coating apparatus for coating objects, comprising an application device which is designed to apply powder coating to regions of the object that are to be coated; and comprising an irradiation device which has at least one electromagnetic radiation source, which is designed to direct electromagnetic radiation onto areas of the object that are to be coated with powder coating and which is designed to thus cross-link the powder coating onto the coated regions. The present invention further relates to a powder-coating method for coating objects by means of a powder-coating apparatus according to the invention.

### BACKGROUND OF THE INVENTION

The present invention relates to a powder-coating apparatus for coating objects. Furthermore, the present invention relates to a powder-coating method for coating objects by means of a powder-coating apparatus.

Coating in production engineering is understood to mean a group of production methods used for applying an adherent layer of amorphous substance to the surface of an object. The coating methods are differentiated into chemical, mechanical, thermal and thermomechanical methods through the way in which the layer is applied.

Powder coating is a coating method in which an electrically conductive object is coated with powder coating. A typical coating installation comprises a surface pretreatment device, an intermediate drying device, an electrostatic coating device and a dryer device.

In the coating device, called application device, the powder to be coated is applied to the object, for example by means of spray guns.

The powder coating is subsequently crosslinked approximately with the aid of a furnace. The temperatures for crosslinking the powder coating are between 110 and 250° C. The exact setting of the furnace temperature and the residence time depends on the powder coating used. The furnace is usually heated by convection. This is done using a hot air flow which cools on the workpiece and the latter thus transfers the heat for crosslinking the powder coating particles with one another. Furthermore, heat transfer to the powder particles by infrared radiation is possible.

DE 101 16 720 A1 describes an apparatus for laser powder coating, comprising a laser source and an apparatus head optically connected thereto. The laser beam is directed to the component surface to be coated, and an additional material present in powder form is simultaneously mixed with the laser beam. By means of the laser radiation, both the powder and a minimal part of the component surface are melted and the additional material supplied is metallurgically bonded to the component material surface.

### SUMMARY OF THE INVENTION

The invention provides a powder-coating apparatus for coating objects and a powder-coating method for coating objects.

Accordingly, provision is made of:

A powder-coating apparatus for coating objects, comprising an application device designed to apply powder coating to regions of the object that are to be coated; and comprising an irradiation device having at least one electromagnetic radiation source designed to direct electromagnetic radiation onto regions of the object that are to be coated with powder coating, and thus to crosslink the powder coating on the coated regions.

Furthermore, provision is made of a powder-coating method for coating objects by means of a powder-coating apparatus according to the invention comprising the following method steps:
(a) providing an object;
(b) applying a powder coating to regions of the object that are to be coated by means of the application device; and
(c) crosslinking the powder coating by means of electromagnetic radiation by means of the irradiation device.

The concept underlying the invention consists in realizing the crosslinking of the powder coating by means of electromagnetic radiation, such that the required temperatures are attained only in the powder layer, rather than the entire component being heated.

In this way, it is possible to coat particularly temperature-sensitive materials, e.g. films for battery cells, by means of a powder coating. Furthermore, the present invention reduces the energy consumption since very efficient electromagnetic radiation sources can be used.

The electromagnetic radiation results in a better crosslinking of the powder layer, such that the latter has a higher strength and hardness. The lifetime of the coating can thus be increased.

In one embodiment of the invention, the electromagnetic radiation is chosen in such a way that it heats the powder coating selectively relative to the coated object in order to crosslink the powder coating. By way of example, the wavelength of the electromagnetic radiation is chosen in such a way that it lies in the absorption range of the powder coating material and not in the absorption range of the object to be coated. In this way, the heat transfer to the object is minimized, such that even very temperature-sensitive and thin-walled parts can be coated.

In a further embodiment, the radiation source is a laser, in particular a diode laser. Diode lasers are very well suited to use in the powder-coating apparatus according to the invention, since they have a very compact design and can be pumped in a simple manner by means of electric current. Furthermore, diode lasers have a very high efficiency, such that the energy consumption for coating the objects can be significantly reduced. Furthermore, diode lasers are very low-maintenance and have a very long lifetime. The coupling-in and transport of the electromagnetic radiation are also very simple by means of diode lasers.

However, other types of lasers, such as, for example, dye lasers, Nd:YAG lasers, argon ion lasers, carbon dioxide or nitrogen lasers, can also be used for the present invention. Furthermore, the use of a maser is also possible. Moreover, the present invention is not tied to specific wavelengths of the electromagnetic radiation. Wavelengths in the range from ultraviolet to far infrared can be used for the transfer of energy to the powder coating. Microwaves can also be used. Depending on the embodiment of the powder coating, the wavelength can be coordinated with the powder coating.

In a further embodiment of the invention, a control device is provided, which is coupled to the radiation source and a temperature sensor arranged on the object to be coated, wherein the radiation power of the radiation sources is controllable by open-loop control and closed-loop control depending on the temperature detected by the temperature sensor. The temperature sensor can be provided, for example, on the rear side of that surface of the object which is to be coated. The radiation power of the electromagnetic radiation source can then be varied depending on the temperature of the object. In this way, it is possible for the material of the object that is to be coated not to be damaged, and for a good crosslinking of the powder coating nevertheless to take place. The radiation power of the radiation source can be controlled by open-loop control or closed-loop control, for example, by pulsed operation of the electromagnetic radiation source or by a change in the wavelength. It is also possible to provide a multiplicity of electromagnetic radiation sources in the irradiation device, wherein the number of active electromagnetic radiation sources can be varied in order to change the radiation power of the irradiation device.

In a further embodiment of the invention, a deflection device is provided, which is designed to deflect the electromagnetic radiation of the radiation source onto the regions of the object that are to be coated. By way of example, the deflection device is embodied in the form of a so-called scanner that directs the electromagnetic radiation line by line and column by column onto the regions of the object that are to be coated. By means of the deflection device, moreover, the total energy transferred from the electromagnetic radiation source to the regions of the object that are to be coated can be controlled in a simple manner.

In a further embodiment of the invention, the wavelength of the radiation source is adjustable by means of the control device. An optimum crosslinking of the powder coating can be obtained in this way.

In a further embodiment of the invention, a process gas device is provided, which is designed to feed process gas into the powder-coating apparatus. The component can be coated very homogeneously in this way. By way of example, inert gases are used as the process gas. A ventilation system, a dehydration installation, etc. can be combined with the process gas device, depending on the application and use of the object to be coated.

The present invention is suitable, in particular, for coating temperature-sensitive components. Moreover, the present invention is particularly suitable for coating white goods, for example components for dishwashers, tumble dryers, washing machines, refrigerators, etc. The powder-coating apparatus and the powder-coating method are also very well suited to metal coatings for protection against corrosion.

The above configurations and developments can, insofar as expedient, be combined arbitrarily with one another. Further possible configurations, developments and implementations of the invention also encompass combinations, not explicitly mentioned, of features of the invention described above or below with regard to the exemplary embodiments. In particular, the person skilled in the art will in this case also add individual aspects as improvements or supplementations to the respective basic form of the present invention.

### BRIEF DESCRIPTION OF THE DRAWINGS

The present invention is explained in greater detail below on the basis of the exemplary embodiments indicated in the schematic figures of the drawings, in which:

FIG. 1 shows a schematic view of a powder-coating apparatus;

FIG. 2 shows a schematic view of an irradiation device;

FIG. 3 shows a schematic view of a powder-coating apparatus; and

FIG. 4 shows a schematic flow chart of a powder-coating method.

### DETAILED DESCRIPTION

The accompanying drawings are intended to convey a further understanding of the embodiments of the invention. The illustrated embodiments in association with the description serve to clarify principles and concepts of the invention. Other embodiments and many of the advantages mentioned will become apparent in view of the drawings. The elements of the drawings are not necessarily shown as true to scale with respect to one another.

In the figures of the drawing, identical, functionally identical and identically acting elements, features and components—unless explained otherwise—are provided in each case with the same reference sign.

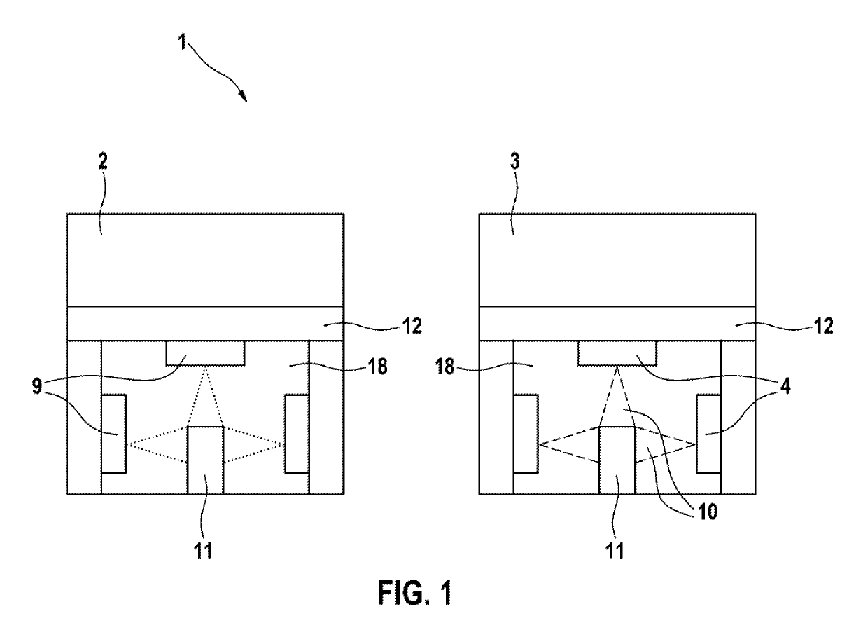

FIG. 1 shows a schematic view of a powder-coating apparatus 1 for coating objects 11. The left-hand side of FIG. 1 illustrates an application device 2 designed to apply powder coating to regions of the object 11 that are to be coated. The application device 2 has a chamber 18 insulated from the surroundings. Carriers 12 are provided in said chamber 18, on which carriers spray guns 9 are provided on all sides around the object 11. The object 11 is held, for example, on a platform (not illustrated). The carriers 12 are mounted displaceably within the application device, such that the object 11 can be provided with powder coating on all sides.

The right-hand side of FIG. 1 illustrates an irradiation device 3. In the irradiation device 3, too, a multiplicity of carriers 12 are provided, which can be arranged displaceably within the irradiation device 3. A multiplicity of electromagnetic radiation sources 4 are provided on the carriers 12. The electromagnetic radiation sources 4 are designed to direct electromagnetic radiation 10 onto regions of the object 11 that are to be coated with powder coating. On account of the radiation energy of the electromagnetic radiation emitted by the radiation sources 4, the particles of the powder coating are crosslinked with one another and form a homogeneous powder coating layer. In this case, the electromagnetic radiation is chosen in such a way that it is absorbed only by the powder coating particles, and not by the material of the object 11. In this way, the object 11 is heated only minimally during the crosslinking of the powder coating particles. In this way, even very temperature-sensitive components, in particular very thin-walled components, can be coated with a powder coating.

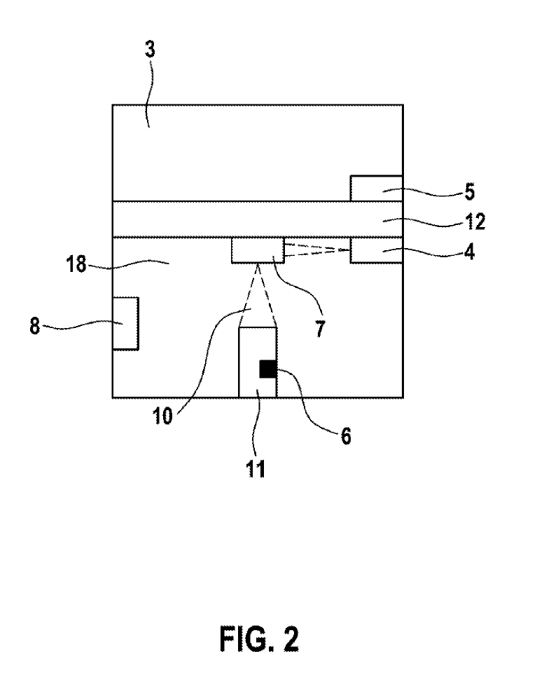

FIG. 2 shows a schematic view of an irradiation device 3. In this exemplary embodiment of the irradiation device 3, a deflection device 7 is provided on the carrier 12, said deflection device being designed to direct the electromagnetic radiation of the radiation source 4 onto the regions of the object 11 that are to be coated. The electromagnetic radiation source 4 emits electromagnetic radiation 10 that is guided to the deflection device 7. The deflection device 7 then directs the electromagnetic radiation 10 onto the regions of the object 11 that are to be coated, for example by means of mirrors provided with an actuator system. In this way, it is possible to reduce the number of electromagnetic radiation sources 4 in the irradiation device 3.

Furthermore, the irradiation device 3 illustrated in FIG. 2 has a control device 5. The control device 5 is coupled to the electromagnetic radiation source 4 and a temperature sensor 6 arranged on the object 11. The control device 5 obtains from the temperature sensor 6 a measured value of the temperature of the object 11 and controls the radiation power of the electromagnetic radiation source 4 depending on the detected temperature of the object 11. If a measured value which exceeds a predefined temperature value is detected, the control device 5 switches off the electromagnetic radiation source 4. When the temperature falls below a predefined temperature, the control device 5 switches the electromagnetic radiation source 4 on again. The power for crosslinking the powder coating particles can be set very accurately in this way.

It goes without saying that it is possible to use continuous closed-loop control instead of open-loop control. For this purpose, use is made of a PID control loop which can continuously adapt the radiation power of the electromagnetic radiation source 4.

The temperature sensor 6 can be arranged, for example, on the rear side of a film to be coated. By way of example, semiconductor temperature sensors, NTC thermistors, PTC thermistors or thermoelements or quartz oscillators can be used as the temperature sensor 6.

Furthermore, in FIG. 2 a process gas device 8 is provided within the chamber 18 of the irradiation device 3. The process gas device 8 can feed a process gas, for example argon or nitrogen, to the chamber 18. In this way, a very homogeneous powder coating layer can be formed on the object 11. In addition, further devices for aeration, dehydration or ventilation can be provided in the irradiation device 3.

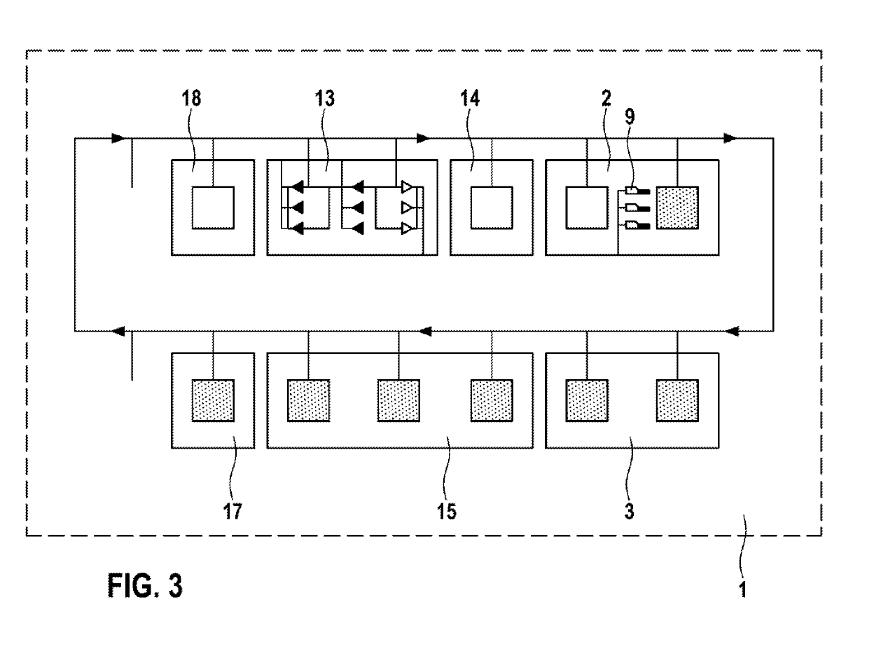

FIG. 3 illustrates a schematic view of a powder-coating apparatus 1. In the region provided with the reference sign 18, the component not yet coated is received into the apparatus 1. A pretreatment of the object 11 to be coated is carried out in the region 13. By way of example, the surface of the object 11 is cleaned of coarse contaminants and the surface is degreased by means of solvents. The object is subjected to intermediate drying in the region 14. The application device 2 is illustrated on the right next to the region 14. In the application device 2, powder coating is applied to regions of the object 11 that are to be coated. For this purpose, spray guns 9 are provided in the application device 2. The object 11 is subsequently led into the irradiation device 3. In the irradiation device 3, the powder coating on the regions of the object that are to be coated is crosslinked by means of an electromagnetic radiation source designed to direct electromagnetic radiation onto the regions of the object that are to be coated with powder coating.

In the region 15, by way of example, an aftertreatment of the object 11 takes place. By way of example, the powder coating is postcured in the region 15. In the region 17, the coated object 11 can be removed from the process chain.

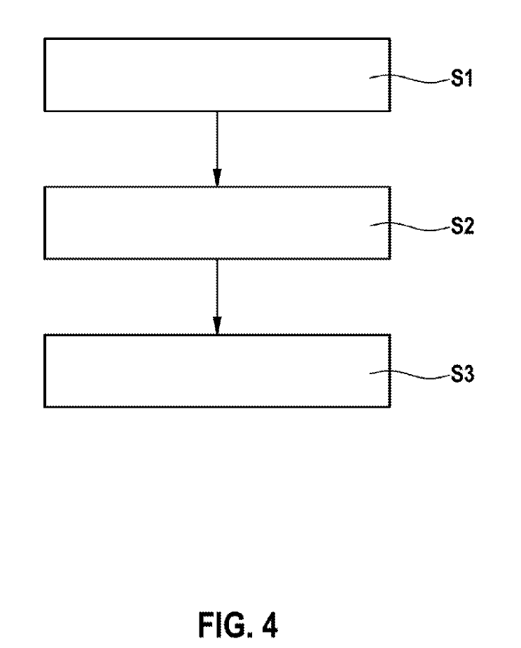

FIG. 4 shows a schematic flow chart of a powder-coating method. In step S1, an object to be coated is provided. In step S2, powder coating is applied to regions of the object that are to be coated. In step S3, the powder coating is crosslinked by means of electromagnetic radiation.

Although the present invention has been described fully above on the basis of preferred exemplary embodiments, it is not restricted thereto, but rather can be modified in diverse ways.

1. A powder-coating apparatus (1) for coating objects (11), the apparatus comprising an application device (2) configured to apply powder coating to regions of an object (11) to be coated; and comprising an irradiation device (3) having at least one electromagnetic radiation source (4) configured to direct electromagnetic radiation (10) onto regions of the object (11) that are to be coated with powder coating, and thus to crosslink the powder coating on the coated regions.

2. The powder-coating apparatus (1) as claimed in claim 1, wherein the electromagnetic radiation heats the powder coating selectively relative to the coated object in order to crosslink the powder coating.

3. The powder-coating apparatus (1) as claimed in claim 1, wherein the radiation source (4) is a laser.

4. The powder-coating apparatus (1) as claimed in claim 1, further comprising a control device (5), which is coupled to the radiation source (4) and a temperature sensor (6) arranged on the object (11) to be coated, wherein radiation power of the radiation source (10) is controlled by open-loop control and closed-loop control depending on a temperature detected by the temperature sensor (6).

5. The powder-coating apparatus (1) as claimed in claim 1, further comprising a deflection device (7), configured to deflect the electromagnetic radiation (10) of the radiation source (4) onto the regions of the object (11) that are to be coated.

6. The powder-coating apparatus (1) as claimed in claim 4, wherein a wavelength of the radiation source (4) is adjustable by means of the control device (5).

7. The powder-coating apparatus (1) as claimed in claim 1, further comprising a process gas device (8) configured to feed process gas into the powder-coating apparatus (1).

8. A powder-coating method for coating objects (11) by means of a powder-coating apparatus (1) as claimed in claim 1 comprising the following method steps:
(a) providing the object (11) to be coated;
(b) applying the powder coating to the regions of the object that are to be coated by means of the application device (2); and
(c) crosslinking the powder coating by means of electromagnetic radiation (10) by means of the irradiation device (3).

9. The powder-coating apparatus (1) as claimed in claim 2, wherein the radiation source (4) is a diode laser.

10. The powder-coating apparatus (1) as claimed in claim 2, wherein the radiation source (4) is a laser.

11. The powder-coating apparatus (1) as claimed in claim 10, further comprising a control device (5), which is coupled to the radiation source (4) and a temperature sensor (6) arranged on the object (11) to be coated, wherein radiation power of the radiation source (10) is controlled by open-loop control and closed-loop control depending on a temperature detected by the temperature sensor (6).

12. The powder-coating apparatus (1) as claimed in claim 11, further comprising a deflection device (7) configured to deflect the electromagnetic radiation (10) of the radiation source (4) onto the regions of the object (11) that are to be coated.

13. The powder-coating apparatus (1) as claimed in claim 12, wherein a wavelength of the radiation source (4) is adjustable by means of the control device (5).

14. The powder-coating apparatus (1) as claimed in claim 13, further comprising a process gas device (8) configured to feed process gas into the powder-coating apparatus (1).
